(19) United States
(12) Patent Application Publication
(10) Pub. No.: US 2026/0358547 A1
(43) Pub. Date: Nov. 12, 2026

(54) Optical Display Device

(71) Applicant: InnerScene Limited, Gloucester (GB)

(72) Inventor: Jonathan Clark, Gloucester (GB)

(73) Assignee: InnerScene Limited, Gloucester, GL (GB)

(21) Appl. No.: 19/671,700

(22) Filed: May 8, 2026

(30) Foreign Application Priority Data
May 10, 2025 (GB) 2507207.5

(51) Int. Cl. F21V 8/00; F21K 9/61

(52) U.S. Cl. CPC G02B 6/0036; F21K 9/61; G02B 6/0061

(57) ABSTRACT

An optical display device arranged to generate output light projected through an output aperture, the device comprising: a diffuse light generation system for generating a diffuse light component of the output light, the diffuse light generation system comprising: a light guide comprising an optically transparent substrate with decoupling features arranged on a surface thereof to decouple light from the light guide as the diffuse light component; a light source arranged to project light into the light guide; an output aperture for output of the output light, wherein the decoupling features are arranged on said surface with a pseudo-random or regular arrangement to prevent unwanted visual artefacts.

### TECHNICAL FIELD

The present disclosure relates to electrically operated optical display devices for creating an artificial sky light, wherein an observer experiences a perception of a sky scene when gazing into an output aperture of said device.

### BACKGROUND

EP2918903B discloses a light guide panel that comprises a distribution of solid particles which are 5nm≤d≤300 nm in size. A drawback with such an arrangement is that particle distribution cannot easily be controlled. Specifically, it is desirable to have an increased density of particles with distance from an edge coupled light source, so that the decoupled light has uniform intensity.

It is therefore known to form decoupling features on a surface of a light guide panel by laser etching. However, such comparatively large decoupling features may be visible to an observer gazing into the light guide panel at close range. It is therefore known to implement a masking diffuser in front of the light guide panel to mask the presence of the decoupling features. A masking diffuser can increase cost and also reduce efficiency due to imperfect optical efficiency.

Therefore, in spite of the effort already invested in the development of said devices further improvements are desirable.

### SUMMARY

### General Device

The present disclosure provides an optical display device to generate output light projected through an output aperture.

In embodiments, the optical display device comprises an output light generation system for generation of the output light. In embodiments, the optical display device comprises the output aperture for output of the output light. In embodiments, the output light generation system comprises a light source to generate the output light. In embodiments, the optical display device comprises electrical circuitry to control the light source. In embodiments, the output light generation system comprises a diffuse light generation system for generating a diffuse light component of the output light.

In embodiments, the optical display device is arranged to create a perception of a virtual sky scene in output light and/or generate in an output aperture a virtual sky scene. In embodiments, the virtual a sky scene is configured to make a user experience distant depth perception, e.g. when gazing into the output aperture. The sky scene (e.g. one or more of its components) may have the perception of distant/infinite depth as defined herein.

In embodiments, the diffuse light generation system is arranged to generate a diffuse sky light component in the output light. A diffuse light generation system may provide an appearance of a clear sky in the sky scene.

In embodiments, the output light generation system comprises a collimated light generation system arranged to generate a collimated sunlight component in the output light. A collimated light generation system may provide an appearance of a sun in the sky scene.

In embodiments, the output aperture comprises a transparent member. The output light is typically transmitted through the transparent member. In embodiments, the transparent member includes an interior face and an exterior face. The interior face may face the output light generation system and an exterior face may face away from the output light generation system, e.g., towards an observer gazing into said device. The output light is typically projected to the interior face, through the thickness of the transparent member, and from the exterior face. In embodiments, the output aperture comprises/is mounted to a frame. In embodiments, the frame extends around the output aperture, e.g., to define the output aperture.

### Diffuser

In embodiments, the diffuse light generation system comprises a light guide comprising an optically transparent substrate. In embodiments, decoupling features are arranged on a surface of the optically transparent substrate to decouple light from the light guide as the diffuse light component. In embodiments, the light source is arranged to project light into the light guide.

### Regular Grid Configuration

In embodiments, the decoupling features are arranged on said surface with a regular grid. As used herein the term “regular grid” may refer to an arrangement of the decoupling features into a arrangement with a geometrically repeating unit. The arrangement may only implement the repeating unit so that there are no other decoupling features that are no part of the repeating unit. The repeating unit may be a tessellation shape.

A regular repeating unit may avoid areas of over or under concentration of decoupling features, which could affect uniformity of a luminance distribution of the output light over the output aperture.

In embodiments, the regular grid formation of the decoupling features satisfies one or more of the following conditions. The conditions may be satisfied for at least 60% or 80% or 90% of the decoupling features. Such a percentage range may provide a negligible amount of decoupling features outside of said conditions, e.g. which are generally imperceivable.

### A. a Maximum Size Condition:

In embodiments, a maximum size of a major dimension of the decoupling features of less than or equal to 0.2 mm or 0.1 mm or 0.08 mm or 0.05 mm. In embodiments, a minimum size of a major dimension of the decoupling features of greater than or equal to 0.001 mm or 0.005 mm or 0.01 mm. Any of the aforesaid maximums and minimums may be combined, for example, 0.1 mm 0.01 mm.

As used herein the term “major dimension” in respect of a decoupling feature may refer to a longest dimension, e.g. an internal dimension between sides. For example: for a circular shape a diameter; for an ovoid or elliptical shape a major diameter; for other polygons including a hexagon or a square or a triangle, a longest distance between vertexes.

A size of decoupling features within this range is formable by known manufacturing techniques, (e.g. a laser or moulding) and may be sufficiently small to prevent visibility by a human observer (e.g. with 20/20 vision from a typical viewing position, e.g. 30 cm or above).

### B. a Minimum Distance Condition:

For any pair of decoupling features i and j located at positions xᵢ and xⱼ, a Euclidean distance dᵢⱼ between the decoupling features satisfies the inequality:

dᵢⱼ=||xᵢ−xⱼ||≥rₘᵢₙ, where rₘᵢₙ∈[a mm],

where rₘᵢₙ is a minimum separation distance between adjacent decoupling features, and A is a bound. rₘᵢₙ may for example may be a minimum distance between peripheries of decoupling features.

By implementing a suitable minimum distance condition for any pair of the decoupling features, a clustering condition which may result in more than one decoupling feature being observed as being a one, or other uniformity related issue in the luminance distribution may be avoided.

A may be 0.01 mm or 0.05 mm or 0.08 mm or 0.1 mm or 1 mm. the condition may also be expressed as rₘᵢₙ=A.

C. A spacing condition: the average spacing between adjacent decoupling features is described by a spatial density function ρ(x), (e.g. how many decoupling features per mm² at point x) such that for any region A⊂ ² of area A, the expected number of decoupling features [symbol] [N_{A}] within that area is given by:

[symbol]

[N_{A}]=∫_{ρ(}x)dA, where [a decoupling features/mm², B decoupling features/mm²]

where ρ(x) is the spatial density distribution of the decoupling features, to avoid both over-concentration and under-concentration dA is an infinitesimal patch of area on the interior surface light guide, and A is the lower bound and B is the upper bound decoupling features per area.

By implementing a suitable a density distribution for the decoupling features, over-concentration and under-concentration may be avoided. Specifically, per mm² there may not fall below A and may not exceed B decoupling features for any given area over the surface that the decoupling features is formed on.

A may be 0.05 or 1 or 10 or 100. B may be 2500 or 1000 or 500 or 200. Any of the aforesaid values for A and B may be combined, e.g. [0.05/mm², 1000/mm²].

### D. a Maximum Distance Condition:

A distance between a first decoupling feature and a second nearest neighbour decoupling feature for any such pair of decoupling features i and j located at positions xᵢ and xⱼ, a distance dᵢⱼ between the decoupling features satisfies the inequality:

dᵢⱼ=||xᵢ−xⱼ||≤rₘₐₓ, where rₘₐₓ∈[A mm]

where rₘₐₓ is the maximum separation distance between adjacent decoupling features, and A is a bound. rₘₐₓ may for example be a distance between centre points of the decoupling features or may be a minimum distance between their peripheries.

By implementing a suitable maximum distance condition for any pair of the decoupling features, a clustering condition which may result in an under concentration being observed, or other uniformity related issue in the luminance distribution may be avoided.

A may be 10 mm or 5 mm or 3 mm or 2 mm or 1 mm. The condition may also be expressed as rₘₐₓ=A.

In embodiments, the regular grid formation comprises a rectangular, hexagonal or triangular grid or other polygon grid.

In embodiments, the regular grid formation is maintained with different sized decoupling features which vary with distance from the light source to provide a uniform luminance distribution over the output aperture.

For example, the same geometry grid may be maintained, but with different sized decoupling features to achieve a uniform luminance distribution accounting for distance of the decoupling features from the light source.

### Pseudo Random Configuration

In embodiments, the decoupling features are arranged on said surface with a random (e.g. a pseudo-random) distribution. As used herein the term “pseudo-random distribution” may refer to an arrangement of the decoupling features into an arrangement which does not include regular repeating arrangement, that may be defined as over a particular area.

A random arrangement may be advantageous since it may reduce phenomena including aliasing and moire patterns.

In embodiments, the decoupling features are arranged on said surface with the pseudo-random distribution such that a spatial arrangement of the decoupling features is governed by a distribution function P(x), with x∈ ² representing the 2D coordinates of each decoupling feature on the surface of the light guide.

In embodiments, the pseudo-random grid formation of the decoupling features satisfies one or more of the following conditions. The conditions may be satisfied for at least 60% or 80% or 90% of the decoupling features. Such a percentage range may provide a negligible amount of decoupling features outside of said conditions, e.g. which are generally imperceivable.

### A. a Maximum Size Condition:

As Discussed for the Regular Grid Example.

### B. a Minimum Distance Condition:

For any pair of decoupling features i and j located at positions xᵢ and xⱼ, a distance dᵢⱼ between the decoupling features satisfies the inequality:

dᵢⱼ=||xᵢ−xⱼ||≥rₘᵢₙ where rₘᵢₙ∈[A mm, B mm,]

where rₘᵢₙ is the minimum separation distance between adjacent decoupling features. rₘᵢₙ may for example may be a minimum distance between peripheries of decoupling features.

By implementing said minimum distance condition for any pair of the decoupling features, a clustering condition which may result in more than one decoupling feature being observed as being an one, or other uniformity related issue in the luminance distribution may be avoided.

Specifically, a minimum Euclidean distance between any pair of decoupling features distributed over the surface on which the decoupling features is formed is within the range of A to B mm.

A may be 0.01 mm or 0.05 mm or 0.08 mm or 1 mm. B may be 3.0 mm or 2.0 mm or 1.0 mm or 0.5 mm or 0.1 mm. Any of the aforesaid values for A and B may be combined, e.g. [0.01 mm, 3.0 mm].

### C. a Spacing Condition:

As discussed for the regular grid example.
   D. A maximum distance condition:
A distance between a first decoupling feature and a second nearest neighbour decoupling feature for any such pair of decoupling features i and j located at positions xᵢ and xⱼ, a distance dᵢⱼ between the decoupling features satisfies the inequality:

dᵢⱼ=||xᵢ−xⱼ||≤rₘₐₓwhere rₘₐₓ∈[A mm, B mm,]

where rₘₐₓ is the maximum separation distance between adjacent decoupling features, and A is a lower bound and B is an upper bound separation distance. rₘₐₓ may for example be a distance between centre points of the decoupling features or may be a minimum distance between their peripheries.

By implementing a suitable maximum distance condition for any pair of the decoupling features, a clustering condition which may result in more than one decoupling feature being observed as being a one, or other uniformity related issue in the luminance distribution may be avoided.

Instead of fixing rₘₐₓ to one value, using a range introduces controlled variability in the distances between decoupling features. If all decoupling features had exactly the same rₘₐₓ spacing artefacts including: repetitive spacing, quasi-periodic patterns, Moiré effects could be created.

A may be 0.5 mm or 1 mm or 2 mm 3 mm or 5 mm. B may be 10 mm or 5 mm or 3 mm or 2 mm or 1 mm. Any of the aforesaid values for A and B may be combined, e.g. [2 mm, 10 mm].

### C. a Low-frequency Periodicity Condition:

The spatial power spectrum S(f) of the pattern of decoupling features, e.g. meaning: how “intense” or “strong” (or energy there is) different spatial frequencies are in the layout of the decoupling features on the light guide, where f is spatial frequency, e.g. how quickly a pattern repeats over space, and satisfies the condition:

S(^{f})∝^{f-α}, with α∈[A, B]
where the exponent α ensures that the spatial power spectrum decays sufficiently at low spatial frequencies (e.g. higher α values mean faster fall-off of light scattering along the guide), and the power at each frequency ^{f} Decreases as f increases, controlled by α.

A may be 0.5 or 1 or 1.5 or 2. B may be 5 or 4 or 3 or 2.5. Any of the aforesaid values for A and B may be combined, e.g. [1, 4].

This range of exponent α may ensure that low-frequency components in the spatial spectrum decay sufficiently, which may prevent strong periodicity in the decoupling feature arrangement, which may minimizing large-scale periodicity that would otherwise result in visible aliasing or moiré patterns.

### D. a Cluster Avoidance Condition:

The local clustering measure Cᵢ for each decoupling feature i in the region surrounding its position xᵢ is defined as:

Cᵢ=1/|B(xᵢ, r_{clust})|·Σⱼ_{_{∈}}_{B(xi,rclust)}1{dij≤{r_{clust}}
where: B(xᵢ, r_{clust}) represents a disk of radius r_{clust} centred at the position xᵢ, the indicator function1{dij ≤{r_{clust}} is equal to 1 if the distance dᵢⱼ between the i-th decoupling feature and any other decoupling feature j within the disk is less than or equal to r_{clust}, and 0 otherwise, the clustering measure Cᵢ is optimized such that it remains below a predetermined threshold, [symbol] _{clust}, with the threshold [symbol] _{clust}∈[A, B].

A may be 0.05 or 0.01 or 0.015. B may be 0.5 or 0.7 or 0.85. Any of the aforesaid values for A and B may be combined, e.g. [0.01, 0.7].

By ensuring that the clustering is within the range [symbol] _{clust}∈ [0.01, 0.7] noticeable localized bright spots may be avoided.

In embodiments, the pseudo-random distribution is subjected to Lloyd's relaxation. Lloyd's relaxation may minimize variance in local decoupling feature density, ensuring a uniform extraction decoupling feature distribution over the surface area.

In embodiments, the pseudo-random distribution is subject to Poisson disk sampling, ensuring each decoupling feature maintains a minimum separation from all neighbouring decoupling features to mitigate clustering in high-density regions.

### General Configuration Features

In embodiments, the arrangement of the decoupling features consists of the decoupling features arranged only on the surface of the light guide (e.g. the decoupling features are not arranged distal said surface within the material of the light guide).

By not distributing the decoupling features through the thickness of the light guide (e.g. as a 3d arrangement) a location of the decoupling features may be precisely controlled in 2d to achieve one or more of the aforesaid conditions.

In embodiments, the decoupling features are arranged as a single layer only, e.g. on an interior surface or on an output surface/exterior surface. A single layer may permit a less complex arrangement with reduced phenomena including moire patterns.

In embodiments, the decoupling features have a visual acuity of less than or equal to 1 arcminute when viewed from a viewing plane 30 cm in an orthogonal direction from the decoupling features.

Such an arrangement may prevent the decoupling features from being visible to an observer under normal viewing conditions gazing into the device. In embodiments, the decoupling features are arranged with at least 300 dpi. Such an arrangement may prevent the decoupling features from being visible to an observer under normal viewing conditions of the device.

In embodiments, the decoupling features are unresolvable (e.g. not visible/identifiable) by an observer with normal 20/20 vision at a viewing distance of 30 cm an orthogonal direction from the decoupling features. Such an arrangement may prevent the decoupling features from being visible to an observer under normal viewing conditions of the device. In embodiments, the decoupling features are formed by laser etching. Laser etching may permit accurate size and positioning of the decoupling features. In embodiments, the decoupling features are formed by moulding. For example, a mould comprising a reverse image of the decupling features may be pressed into the light guide. The reverse image of the decoupling features may be formed on the mould by laser etching.

In embodiments, an occupancy area of a sample area (e.g. a square of a preset dimension, including of 1 cm side length) of a surface occupied by the decoupling features increases with increasing distance from the light source. The occupancy area may refer to an amount of the sample area (e.g. in % or other numerical quantity) occupied by the decoupling features, which can be achieved by varying quantity and/or size of decoupling features. By increasing the area occupied by the decoupling features with distance from the light source, uniform luminance distribution may be achieved. In embodiments, the occupancy area in creases to a first point. The first point can be an opposed edge, e.g. for arrangements where there a light source which is not arranged opposed to another light source. The first point can be a centre of the light guide, e.g. for arrangements where there is a light source arranged opposed to another light source. In embodiments, an average luminance measured (e.g. in candelas per square meter (cd/m²)) at an output surface of the light guide or at the output aperture for a given sample area (e.g. a square or circle of a preset dimension, including 1 or 10 cm side length or diameter) does not vary by more than 10% or 15% or 20%. Said variation may be for at least 70% or 80% or 90% of the output surface/output aperture.

Such a luminance distribution may appear as uniform to an observer, which may increase realism of the device.

In embodiments, the optical display device is arranged with a region between the output aperture and an output surface of the light guide to be absent a masking diffuser, which would otherwise mask the decoupling features. By implementing the aforementioned arrangements of the decoupling features, their visibility and/or phenomena including aliasing and moire patterns may be avoided, hence there is no need to implement a masking diffuser downstream of the light guide.

As used herein the term “masking diffuser” may refer to a specific arrangement to implement diffuse, scattering light to soften/obscure prior art light guides with visible decupling features and/or moire patterns and aliasing caused in relation thereto. An example of a masking diffuser comprises a “frost” covering on a substrate. A frost covering can be achieved by etching or sandblasting of the substrate, e.g. a glass or plastic based material including PMMA or PC.

In embodiments, the output light between an output surface of the light guide and the output aperture (e.g. its output surface) experiences no more than a drop of 2.5% or 5% or 7.5% or 10% or 15% or 20% in intensity. The drop may be due to the transparent member of the output aperture only, which may be a clear plastic e.g. acrylic or glass. A small drop in intensity only may be achieved by the absence of a masking diffuser, which typical otherwise causes a drop in intensity (and therefore efficiency) of 10-30%. In embodiments, the optical display device comprises an optically reflective back panel arranged on an opposed side to an output surface of the light guide to reflect light back to the waveguide. By implementing a reflective back panel (e.g. a reflective member), light that decuples and exits the light guide from an interior surface of the light guide may be reflected back into the light guide and subsequently output via the output surface, which may increase device efficiency. In embodiments, the optical display device is arranged for transmission of light entirely through the optical display device. Specifically, it may comprise an output aperture on either side of the light guide, without an opaque material therebetween. For example, the optical display device may be implemented as a real-life window or skylight or an interior window. In such examples, the light source may be switched on to provide additional light, a privacy effect in privacy glass or the display of a message/graphical work.

In embodiments, the waveguide comprises a minimum thickness of at least or equal to 0.2 mm or 0.25 mm or 0.5 mm or 1 mm or 2 mm. In embodiments, the waveguide comprises a maximum thickness of less than or equal to 3 mm or 5 mm or 10 mm or 15 mm or 20 mm or 50 mm. Any of the aforesaid limits may be combined, e.g. 0.25 mm to 15 mm. In embodiments, the waveguide device comprises a side length of 25 cm to 2 m.

In embodiments, the optical display device is arranged as a viewing arrangement for an object, for example as artwork or a message or a graphical work. The light source and light guide may provide unform illumination of the object.

In embodiments the diffuse light component is uniform to the extent where the intensity and/or colour does not vary by more than 10% or 20% or 30% or 40% for any given circular area on the output aperture of 10 mm or 50 mm diameter. Said variation may be for over at least 60% or 70% or 80% or 90% of the output aperture. Such a uniformity may provide/support a perception of distant or infinite depth of the diffuse sky light component.

In embodiments, the light source comprises a side lit arrangement in which light is projected parallel to a plane of the light guide. By implementing an edge lit light guide, efficient coupling of the light to the light may be achieved without disrupting the visual appearance through the output aperture. In embodiments, the diffuse light generation system is arranged to generate a diffuse sky light component that presents as a clear sky component in the sky scene. In embodiments, the clear sky component is blue, although other colours may be implemented, e.g., grey, reds, purple (e.g., to represent sunset or sunrise).

In embodiments, a collimated light generation system is arranged to generate collimated light that presents as a sunlight component in the sky scene, the sunlight component may be projected through the light guide. Such an arrangement may provide convenient integration of sunlight and skylight creation.

In embodiments, the light source comprises a plurality of LEDs. In embodiments, the LEDs have at least 2 or 3 different colours (e.g. RGB; RGBW; BYW; BGW; BGWW). In embodiments, each colour is independently controllable as a channel of the same colour LEDs. The LED colours/channels may be controllable to achieve a desired colour and/or intensity of the output light. Specifically, the light sources may be independently controllable to produce colour to follow a curve in a chromaticity diagram that is representative of a daylight locus. The control may be to achieve a CCT of a maximum of at least 12,000 K or 15,000 K or 20,000 K or 30,000 K.

In embodiments, electrical circuitry is implemented to control the light source. In embodiments, the electrical circuitry is implemented as one or more processors. In embodiments, the processors are implemented as part of the device or distributed in the system. The processors may execute program code stored on electronic memory and/or may execute programable logic, e.g., as a logic array, gate array, structured array etc.

### Light Guide

The precent disclosure provides a light guide comprising an optically transparent substrate with decoupling features arranged on a surface thereof to decouple light from the light guide as a diffuse light component.

In embodiments, the decoupling features are arranged on said surface with a regular grid formation according to any preceding embodiment, or another embodiment disclosed herein.

In embodiments, the decoupling features are arranged on said surface with a pseudo random arrangement according to any preceding embodiment, or another embodiment disclosed herein.

### [Use]

The present disclosure provides use of a device of any preceding embodiment, or another embodiment disclosed herein for creating a perception of a sky scene.

The present disclosure provides use of a waveguide of any preceding embodiment, or another embodiment disclosed herein for creating a diffuse light component.

### Method of Assembly

The present disclosure provides a method of assembling an optical display device, which may be arranged to create a perception of a sky scene (e.g., in output light) and/or to generate in an output aperture a virtual a sky scene which is configured to make a user experience distant depth perception. The method may implement the features of any preceding embodiment, or another embodiment disclosed herein.

In embodiments, the method comprising forming decoupling features on a surface of a waveguide or on a surface of a member to be optically coupled to a surface of a waveguide.

In embodiments, the method comprises arranging the decoupling features on said surface with a pseudo-random distribution. In embodiments, the method comprises implementing Poisson disk sampling to ensure each decoupling feature maintains a minimum separation from all neighbouring decoupling features to mitigate clustering in high-density regions. In embodiments, the method comprises implementing Lloyd's relaxation to minimize variance in local decoupling feature density, ensuring a uniform extraction decoupling feature distribution over the surface area.

In embodiments, the method comprises arranging the decoupling features on said surface with a regular grid.

In embodiments, the method comprises programming a laser system to form the decoupling features with one of said arrangements. In embodiments, the method comprises implementing a laser and/or a mould (e.g. the decoupling features are formed in reverse on the mould) to form the decoupling features with one of said arrangements.

### Method of Generating Sky Scene

The present disclosure provides a method of generating output light, which may be projected through an output aperture. The method may implement the features of any preceding embodiment or another embodiment disclosed herein.

In embodiments, the method comprises: emitting light from a light source into a light guide; decoupling the light from the light guide by decoupling features arranged on a surface of the light guide or on a surface of a member optically coupled to the light guide as a diffuse light component; emitting the diffuse light component through an output aperture.

In embodiments, the method comprises decoupling the light from the light guide by decoupling features arranged a regular grid formation according to any preceding embodiments or another embodiment disclosed herein.

In embodiments, the method comprises decoupling the light from the light guide by decoupling features arranged a pseudo random arrangement according to any preceding embodiments or another embodiment disclosed herein.

In embodiments, the method comprises creating a perception of a sky scene. In embodiments, the method comprises projecting the output light through a transparent member of an output aperture.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Figures, and Claims.

### BRIEF DESCRIPTION OF FIGURES

Aspects, features and advantages of embodiments of the present disclosure will become apparent from the following description of embodiments in reference to the appended drawings in which like numerals denote like elements.

FIG. 1 is a block system diagram showing an embodiment system for creating an artificial sky scene.

FIGS. 2 and 3 are block system diagrams showing embodiment optical display devices for creating an artificial sky scene of the system of FIG. 1.

FIG. 4 is an illustrative diagram showing the embodiment optical display device of FIG. 3.

FIG. 5 is a block system diagram showing an embodiment optical display device for creating an artificial sky scene of the system of FIG. 1.

FIG. 6 is an illustrative diagram showing the embodiment optical display device of FIG. 5.

FIG. 7 is a plan illustrative view showing decoupling features with a regular grid arrangement of a waveguide for the device/system of FIGS. 1 to 6.

FIG. 8 is a plan illustrative view showing decoupling features with a random arrangement of a waveguide for the device/system of FIGS. 1 to 6.

### DETAILED DESCRIPTION OF EMBODIMENTS

Before describing several embodiments of the device, it is to be understood that the device is not limited to the details of construction or process steps set forth in the following description. It will be apparent to those skilled in the art having the benefit of the present disclosure that the device is capable of other embodiments and of being practiced or being carried out in various ways.

The present disclosure may be better understood in view of the following explanations:

As used herein the term “optical display device” or “device” may refer to electrically operated optical apparatus that is capable of providing an observer with a perception of a real-life sky when gazing into an output aperture of the device, viewed from downstream of the output aperture. The device may create a virtual sky scene. The virtual sky scene may have a perception of distant/infinite depth (as for a real-life sky). The device comprises an output light generation system for generation of output light through an output aperture. The device may be dimensioned such that it is suitable for attachment to a ceiling or wall (e.g. a side wall, including a window) of an interior or a building. The device may include a mounting structure, e.g. brackets for mechanical fixings, for mounting to said ceiling or wall. A dimension of the device may be: less than 1.5 meters or 2 meters or 3 meters in lateral and/or longitudinal dimension; greater than 0.2 meters or 0.3 meters in lateral and/or longitudinal dimension; less than 0.5 meters in depth, any of the aforesaid dimensions may be combined to provide a suitable range. The output aperture may extend over a substantial amount of the lateral and/or longitudinal dimension of the device, e.g. within a frame that frames the output aperture that has a peripheral width of 0.5-5 cm in said lateral and/or longitudinal dimension. The device may be configured to be powered by a mains electrical supply, e.g.110-120v or 220-240v ac.

As used herein the term “output light generation system” may refer to a single (or a distributed system) capable of generating the output light. The output light generation system may generate all the output light, or part of the output light. For example, output light may also include a portion of light down stream of the output aperture (e.g. other lighting in a room where said device is installed) which is transmitted into the device, via the output aperture, reflected and projected back out. The output light generation system maybe implemented as a diffuse light generation system which generates a diffuse light component of the output light. The output light generation system maybe implemented as a collimated light generation system which generates a collimated light component of the output light.

As used herein the term “artificial sky light component” or “diffuse light component” may refer to artificial light that is representative of a real-life sky light component (e.g., absent the real-life sun light component) which can include a clear sky component during daylight, sunset or sunrise and an optional cloud component. It may be representative of the real-life sky light component in respect of one or more of: colour, e.g., as defined by a CCT (e.g., 5000-10000K), the colour may only be blue or optionally white/grey, e.g. to exclude sunrise/sunset conditions; diffusivity; luminance profile or intensity; other suitable parameter, and; a variance of any of the aforesaid over an output aperture of the device. The diffuse light component may be uniform such that is does not vary by more than 10% or 20% or 30% or 40% over the entire output aperture, e.g., in terms of one or more of: colour; luminance (e.g. in candelas per square meter (cd/m²), including luminance profile); intensity, and other suitable parameter. More particularly, said one or more parameters may be uniform to the extent where they do not vary by more than 10% or 20% or 30% or 40% for any given circular area on the output aperture of 10 mm diameter over at least 90% of the output aperture. In a particular example, the diffuse light is propagated over a HWHM solid angle that is at least 4 times larger or 9 times larger or 16 times larger than for the subtending HWHM solid angle of the sun light measured in Sr. The artificial sky light component may have a lumen of 3000-10.000, or 4000-7000. The diffuse sky light component in the output light may have a Lambertian distribution. A Lambertian distribution may refer to a type of diffuse reflection or scattering of light from a surface. The Lambertian model assumes that a surface reflects light uniformly in all directions. This means that the intensity of the reflected light is proportional to the cosine of the angle between the incoming light direction and the surface normal.

As used herein the term “sun light component” or “collimated light component” may refer to artificial light that is representative of a real-life sun light component. It may be representative of the real-life sun light component in respect of one or more of: colour, e.g. as defined by a CCT (e.g. 3000-5000k, which is less than that of the sky light component); divergence (e.g. an angle of divergence of the light rays may be no more than 5 or 2 or 1 or 0.5 degrees relative each other); luminance profile or intensity; other suitable parameter, and; a variance of any of the aforesaid over an output aperture of the device. In a particular example, the luminance profile of the sun light may have a narrow peak in the angular distribution around the direction of propagation which is subtended by a HWHM solid angle smaller than 0.2 sr or 0.3 sr. The sun light component may be projected uniformly over the output aperture, e.g., such that an average direction of propagation within a circle of diameter 10 mm at any position over the output aperture does not vary in angle by more than 2 or 5 or 10%. The sun light component may present to a user when looking into the device, as a circular disc positioned at infinity. As used herein the term “collimated light” may refer to light that has been processed by a collimated light generation system, which may form the sun light component. As used herein the term “real-life sky” may refer to a sky view that an observer observes when gazing through a window (e.g., in a side wall or ceiling) of a structure or otherwise from the ground. The portion of the sky view observed typically comprises the sun and surrounding sky and clouds, but in some cases, it may only comprise only the sky and/or clouds. Hence a real-life sky may include a real-life sky light component and/or may include a real-life sun light component. The real-life sun light component may include a circular (including substantially circular) yellow/white sun (e.g., a warm colour) and includes direct light. The real-life sky light component includes indirect light from the sun and is absent the real-life sun light component. The real-life sky light component may include a clear sky component, e.g., a blue/cold colour and/or a cloud component, e.g., a white/grey colour, which may have the appearance of swirls and cloud like formations. The real-life sky light component may surround (including partially or fully) the circular sun.

The optical display device may recreate characteristics of said real-life sky. As used herein, the term “characteristics of a real-life sky” may refer to any optical characteristic of the real-life sky that is capable of measurement and replication in output light from the optical display device. A characteristic may include one or more of the following: a real-life colour of a real-life sky light component; a real-life colour of a real-life sun light component; a real-life intensity of a real-life sky light component; a real life intensity of a real life sun light component; an angle of the real life sun light component. As used herein, the term “intensity” may refer to any quantity related to a brightness perceived by a user, e.g., one or more of a: radiant intensity, measured in watts per steradian (W/sr); luminous intensity, a measured in lumens per steradian (lm/sr), or candela (cd); Irradiance; luminous power, or luminous flux) measured in lumen. As used herein, the term “colour” may refer to a colour measured by a suitable colour system which may enable digital representation, e.g., colour correlated temperature (CCT) or a colour space, including RGB, sRGB, a Pantone collection, CIELAB or CIEXYZ etc. As used herein, the term “real-life colour” may refer to a colour as measured by a colour system, which is assigned, e.g., as an average or other numerical approximation, to an object. The object can be the sun or the sky or the clouds. Said colour of the object may be measured without interference (including substantial interference) from other objects in the sky scene. As used herein “warm” in respect of the sun light component may refer to a yellow and/or white colour. The CCT may be 3000-5000k. As used herein “cold” in respect of the sky light component may refer to a blue and/or white colour. The CCT may be 5000-10000K.

As used herein the term “perception of infinite depth” may refer to a depth of an object (e.g., the sky and/or sun) in three dimensions being perceived as infinitely far away from an observer with stereopsis (e.g., binocular vision). A perception of infinite depth may be provided by one or more of: binocular convergence; motion parallax, and; accommodation visual depth perception cues, e.g., no conflict exists between these visual perception cues. The condition of infinite depth may be determined based on gaze vectors of the eyes of an observer with normal vision having the same and/or a similar alignment when looking into the device as for looking at the sky and/or sun in the real-life sky. The condition of infinite depth based on motion parallax may be determined based on the image of the sun appearing to be projected from the same location, e.g., moving, as an observer moves laterally and/or longitudinally across the output aperture. An observer user may maintain the same gaze vector associated with infinite depth during said motion.

As used herein the term “distant depth” may refer to a condition of infinite depth or other substantially far field depth, e.g. at least 5 or 10 or 20 or 50 or 100 metres in a depth direction from the output aperture. It may be defined by gaze vectors as mentioned previously of an observer gazing (e.g. from both their eyes, with normal vision) into the output aperture converging to a depth distance beyond the device, e.g. to one of said distance ranges discussed above. As used herein the term “sky scene” or “virtual sky scene” may refer to a scene comprising a virtual representation that an observer observes when gazing through the output aperture of the optical display device. A sky scene may include a virtual sky light component and/or may include a virtual sun light component. The sky scene may include a circular (including substantially circular) sun coloured image of the sun light component. The sun may be surrounded (including partially or fully) and/or overlapped (including partially or fully) by the sky light component. The sky scene may include only the diffuse sky light component. As used herein the term “perception of a sky scene” may refer an observer perceiving a sky scene as being present in the real world, based on the construction by the device of a virtual sky scene that is sufficiently representative, e.g., in terms of chromatic and spatial distribution of light, to present as in the real-life sky.

As used herein the term “output aperture” may refer to a viewing window of the device into which an observer can gaze. The output aperture may be 0.2-3 m in lateral and/or longitudinal dimension. The output aperture outputs the output light which is generated by the device. The output aperture may include a transparent member or a void instead of such a member. The output aperture may include a frame that frames the transparent member. As used herein the term “transparent member” may refer to a medium through which the output light is projected. The transparent member may be planar. The transparent member may be formed of glass or plastic or other suitable material.

As used herein the term “reflective member” may refer to an object that is capable of reflecting an image by specular reflection. It can include a member with any surface in which the texture or roughness of the surface is smaller (smoother) than the wavelength of the incident light. It may include surfaces formed of one or more of the following reflective materials: metals; metal oxides, and; dielectric materials. Examples of which include silver, aluminium, a titanium oxide based material including titanium dioxide or titanium trioxide. Any of the aforementioned may be applied as a thin coating on a glass carrier.

As used herein the term “diffuse light generator” or “diffuse light generation system” may refer to a single or a distributed system capable of generating the diffuse light component, e.g., light which is scattered at many angles as opposed to one angle as with specular reflection/collimated light. The diffuse light generator may generate the diffuse light component by redirecting/scattering light that is incident/encounters decoupling features. The light may be supplied by a dedicated light source. The diffuse light generator may be at least partially transparent and may at least partially generate the diffuse light component from the light transmitted therethrough (which can include light from the collimated light generation system).

As used therein the term “decoupling features” may refer to formations located on a surface of a light guide of discrete shape and formation, which are configured to reorientate and scatter incident light at an angle sufficient to escape total internal reflection of the light guide. The decoupling features may for example be one or more of the following shapes: circular; polygon, including rectangular and triangular. Said shape may be approximate in formation accounting for manufacturing imprecision. The decoupling features may be formed by one or more of: discontinuities formed by a change on the surface, e.g. formed by etching due to a laser, mechanical etching, or chemical etching or formed by pressing a mould into the surface; members coupled to the surface, e.g. prisms or other suitable formations. The decoupling features may be configured to decouple the light from the light guide with a same/similar diffusivity/scattering as is found in a real-life skylight component of a real-life sky.

In other examples the decoupling features may be distributed in the material of the light guide, e.g. as particles to scatter light. As used herein the term “scattering light” may refer to a process performed on light by the diffuse light generator to generate diffuse light, any may include Rayleigh scattering. As used herein the term “particles to scatter light” may refer to particles with a diameter selected to scatter some or all wavelengths of visible light. The diameter of the particles may be micro or nano (e.g., to operate in the Rayleigh regime). The diffuse light generator can include said particles arranged in a medium, e.g., as a waveguide. Examples include titanium dioxide suspended in PMMA.

As used herein the term “light guide panel” or “waveguide” may refer to a generally planar member, which is arranged to convey light in an in-plane direction, e.g., by total internal reflection. The waveguide may be edge lit or otherwise lit by a light source. The waveguide may be implemented as the diffuse light generator, e.g., with a diffuse light component to exit the waveguide upon encountering a decoupling feature.

As used herein the term “collimated light generation system” may refer to a system for processing light from a light source to the collimated light. It may include one or more of the following collimating systems: a lens, including a Fresnel lens; a parabolic reflector; a closed cell structure, through the cells of which light is projected, and; other suitable system. The collimated light generation system may include a light source.

As used herein the term “light source” may refer to any arrangement capable of generating artificial light. It can include arrangements that transform electrical current into a light emission, e.g. as luminous radiation. The light may have wavelengths in the range of 400-700 nm. The light source can include one or more of the following: a white light source, or perceived as such by the eye, e.g., an incandescent lamp, a fluorescent lamp, a mercury vapor discharge lamp; an LED or a white light laser diode (e.g. including a primary source combined with a phosphor or several phosphors) or a combination of LEDs or laser diodes of different colour, and; other suitable light source. LEDs may for example be provide of at least three different colours, with control of same colour channels of the LEDs by the electrical circuitry to control a colour an intensity of the light source. The light source may include a light guide panel to receive light from an emitting portion and convey the light, e.g., by total internal reflection, to an output surface. The light source may be arranged to emit with a CCT of 3K to 20K, or over a daylight locus. The light source may include a light guide to guide the light to the output light generation system or the other components of the output light generation system.

As used herein, the term “prism sheet” or may refer to an arrangement of prisms on a planar member, which maintain an initial degree of collimation of an incident light beam, but which expands said beam. The expansion may be achieved by reflection or reflection and/or refraction. An example of such an arrangement is disclosed in WO2017048569A. As used herein, the term “electrical circuitry” or “circuitry” or “control electrical circuitry” may refer to one or more hardware and/or software components, examples of which may include: one or more of an Application Specific Integrated Circuit (ASIC) or other programable logic; electronic/electrical componentry (which may include combinations of transistors, resistors, capacitors, inductors etc); one or more processors (e.g. circuitry structure of the processor); a non-transitory memory (e.g. implemented by one or more memory devices), that may store one or more software or firmware programs; a combinational logic circuit; interconnection of the aforesaid. The electrical circuitry may be located entirely at one component of the system, or distributed between a plurality of components of the system (e.g. a server system and/or external device) which are in communication with each other over a computer network via communication resources.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board or distributed as part of the system. As used herein, any machine executable instructions, or computer readable media, may be configured to cause a disclosed method to be carried out, e.g. by the system or components thereof as disclosed herein, and may therefore be used synonymously with the term method, or each other.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); Ethernet, DMX, or other protocol implementations. The device may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet; personal area networks (PANs), including with Bluetooth a short-range wireless technology standard.

As used herein, the term “external device” or “external electronic device” or “peripheral device” may include electronic components external to one or more of: the device, and; the server system, e.g. arranged at a same location or remote therefrom, which communicate therewith over a computer network. The external device may comprise a communication interface for electronic communication. The external device may comprise devices including: a smartphone; a PDA; a video game controller; a tablet; a laptop; or other like device.

As used herein the term “database” may refer to a data storage configuration which may be implemented as a key-value paradigm, in which an electronic record as a key and is associated with a value.

As used herein, the term “server system” may refer to electronic components external to one or more of: the device, and; the external device, e.g. arranged at a same location or remote therefrom, which communicate therewith over a computer network. The server system may comprise a communication interface for electronic communication. The server system can include: a networked-based computer (e.g., a remote server); a cloud-based computer; any other server system.

As used herein, the term “viewed from downstream of the output aperture” may refer to any and/or all viewing positions that are achievable by a user from downstream (e.g., from a side of a transparent member of the output aperture comprising an exterior face) the output aperture.

### General System Description

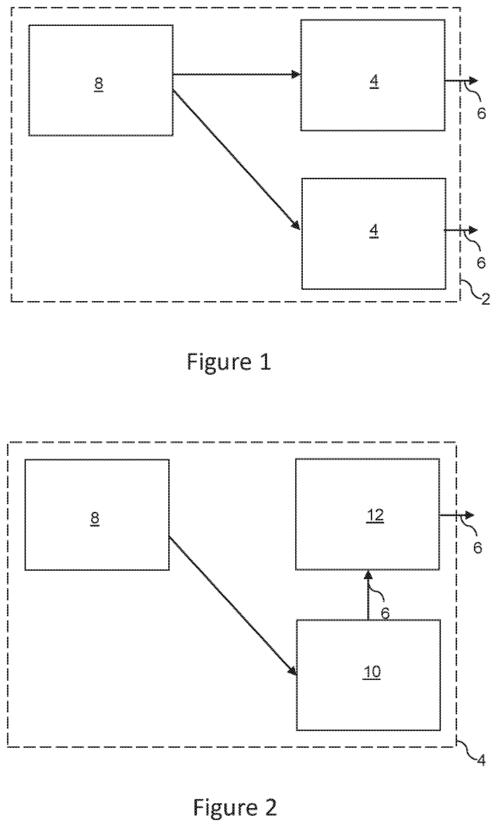

Referring to FIG. 1, the system 2 comprises: devices 4 for output of output light 6, and electrical circuitry 8 for control of various characteristics of the output light 6, as will be discussed. The electrical circuitry 8 may be distributed on one or more of: one or more of the devices 4; a server system (not illustrated); an external device (not illustrated).

In variant embodiments, which are not illustrated: the system comprises a single or other number of devices; in the instance of multiple devices, said devices can be arranged in series with each other as a combinatory assembly; each device comprises its own dedicated electrical circuitry rather than the electrical circuitry controlling multiple devices.

Referring to FIG. 2, a general device 2 comprises: an output light generation system 10 for generation of the output light 6; an output aperture 12 for of the output light 6, and the electrical circuitry 8 for control of the output light generation system 10. The output light 6 is generally projected in the depth directed 104, which is orthogonal to the plane of the output aperture 12.

### First Example

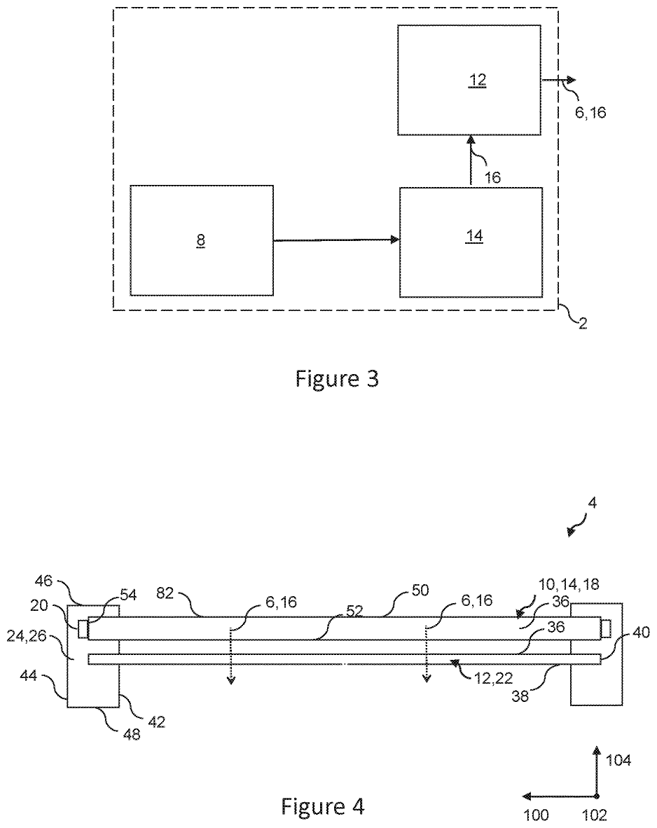

Referring to FIG. 3 a first example of the device 2, which incorporates features and associated variants of the aforedescribed general device 2, comprises the output light generation system 10 arranged as a diffuse light generation system 14. In the first example, the output light generation system 10 does not comprise a collimated light generation system, hence the output light 6 includes only a sky light component 16.

Referring to FIG. 4, in further detail the first example comprises the diffuse light generation system 14 arranged with a light guide 18 and a light source 20. The output aperture 12 comprises a transparent member 22 and is defined by a frame 24. The device 2 includes a housing 26 to house said components.

The output aperture 12 is planar and is aligned in the longitudinal direction 100 and lateral direction 102. A thickness of the device 4 is arranged in the depth direction 104.

The frame 24 surrounds the transparent member 22 and gives an impression of a real-life window or skylight frame.

The light guide 18 includes an opposed interior face 50 and exterior face 52, which interconnect a side face 54. The light source 20 is optically coupled to the side face 54 and emits light in the longitudinal direction 100 through the side face 54 and into the light guide 18. Decoupling features (not illustrated in FIG. 4) scatter the internally reflected light in the light guide 18 and propagate the light as diffuse light from the exterior face 52.

The decoupling features may also scatter the internally reflected light from the interior face 50, in which case a back reflector/back panel (not illustrated) may be implemented for reflect this light back through the light guide 18 and through the exterior face 52. An example of this arrangement comprises the back panel arranged as a mirror or other suitable reflective member.

The light emitted from the light source 20 is retained within the light guide 18 by total internal reflection until it encounters a decoupling feature and is scattered enabling it to exit the light guide 18 as the diffuse sky light component 18.

In variant embodiments, which are not illustrated: the diffuse light generation system is alternatively configured; the decoupling features are throughout the thickness of the light guide, which are configured to decouple the light therefrom; the diffuse light generation system comprises a backlit rather than an edge lit arrangement.

The transparent member 22 includes an interior face 36 that faces into the device 2, and into the output light generation system 10 and an exterior face 38 that faces away from the device 2 (which an observer gazes directly into) and a side face 40 extends between the interior face 36 and the exterior face 38 and around a periphery of the interior face 36 exterior face 38. The transparent member 22 is aligned in the longitudinal direction 100 and lateral direction 102.

The frame 24 includes: an interior side face 42; an outer side face 44; a top face 46, and; a bottom face 48. The top face 46 is arranged at a greater depth in the depth direction 104 than the bottom face 48.

### Second Example

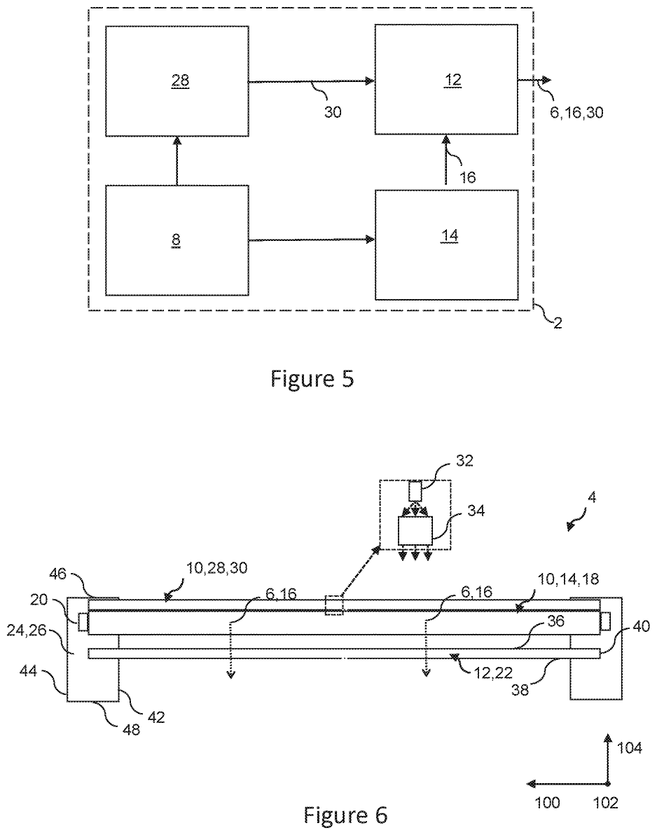

Referring to FIGS. 5 and 6 a second example includes the features of the first example and associated variants, but with the output light generation system 10 additionally implementing a collimated light generation system 28 to generate a sun light component 30.

The collimated light generation system 28 includes a light source 32 and a collimating system 34. The light source 32 projects a light beam (not illustrated) to the collimating system 34, which processes the received light beam to output collimated light which subsequently becomes the sun light component 30.

The light source 32 is implemented as a 2-dimmensional array of LEDs, which can be arranged on a common substrate (not illustrated) that extends in the lateral direction 100 and the longitudinal direction 102. The collimating system 34 is implemented as a 2-dimmensional array of lenses (not illustrated), each of which being associated with an LED. A homogenising element (not illustrated) may optionally be implemented subsequent to the collimating system 34 to remove stray light which may be introduced by the collimating system 34 and/or the light source 32, e.g. as an absorbent honeycomb through which the collimated light passes.

In variant embodiments, the collimated light generation system is alternatively implemented, including: as a single or 1-dimensional array of light sources, which are expanded over the output aperture, e.g. by using an expansion system, which can include one or more reflective members and prism sheets; the collimating system is alternatively implemented as parabolic reflectors or other collimating systems; the collimated light generation system is implemented as a laser light source or other source with a collimated output, which may obviate the collimating system. The collimated light generation system may also be separate from the diffuse light generation system, e.g., as a spotlight.

### [Decoupling Features of Light Guide]

Referring to FIGS. 4, 7 and 8, the light guide 18 (e.g. as implemented in the first or second example or another embodiment disclosed herein) includes on (e.g. including only on) the interior surface 50 decoupling features 60.

By not distributing the decoupling features through the thickness of the light guide (e.g. as a 3d arrangement) a location of the decoupling features may be precisely controlled in 2d to avoid non-uniform regions and other phenomena including aliasing and moire patterns. The precise size and arrangement of the decoupling features can be achieved by laser etching or in other examples a mould (which itself can be formed by laser etching) the is pressed into the light guide surface.

In variant embodiments, which are not illustrated, the decoupling features may alternatively (e.g. including they may be arranged only on) or additionally be arranged on the exterior surface of the light guide or on another member optically coupled to one or both of said surfaces. In other examples, the conditions of the arrangement (e.g. for a regular or pseudo random arrangement as discussed below) may be implemented for a 3D arrangement.

### Regular Grid

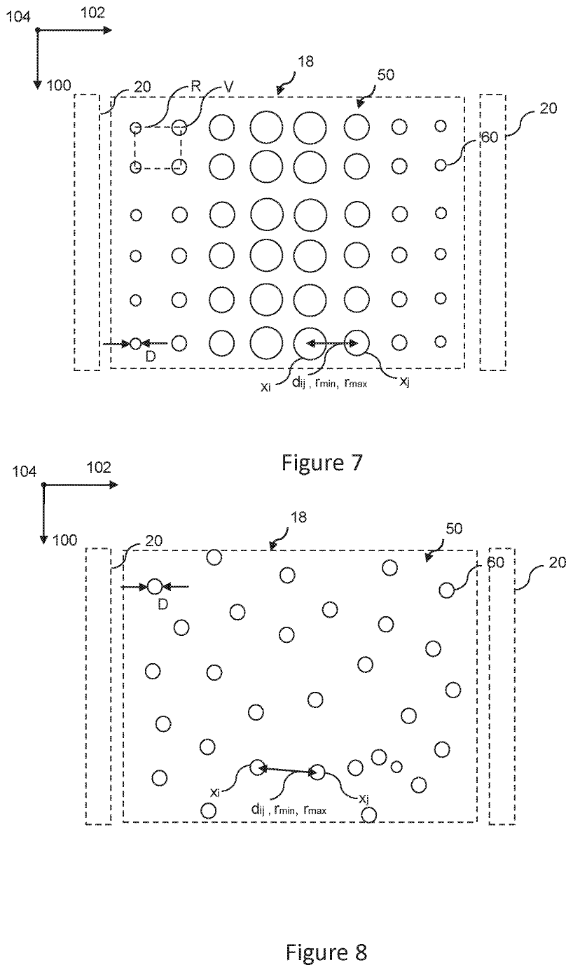

Referring to FIG. 7 the decoupling features 60 are arranged on said interior surface 50 with a regular grid formation which comprises a centre of each decoupling feature 60 arranged at a vertex V of a repeating unit R which is rectangular. The repeating unit R repeats for the arrangement of the decoupling features 60 throughout the interior surface 50.

In variant embodiment, which are not illustrated, the repeating unit may have other arrangements, e.g. triangular, hexagonal or other polygon. Preferably a tessellating shape is implemented for consistent distribution of decoupling features.

The decoupling feature 60 are illustrated as being circular with a major dimension/diameter D.

In variant embodiments, other shapes may be implemented, for example one or more of: square; triangular; hexagonal; other polygon. In such examples the major dimension/diameter may refer to a maximum length (e.g. a length scale) between vertices of the shape. The shape may be formed by any of the processes discussed herein, including as a 2-dimensional or 3-dimensional formation.

The decoupling feature 60 are identified with the subscript Xn, with the n subscript assigned in a logical manner. For example: n begins at 1 in the top left (e.g. the minimum longitudinal direction 100 and lateral direction position 102); for each row n increments by 1 for each decoupling feature 60 in the longitudinal direction 100 for a fixed lateral 102 direction position, and; at the end of a row, the same incrementing is repeated for the next row.

The following conditions are implemented:

### A. a Maximum Size Condition:

The maximum diameter D of the decoupling features 60 is less or equal 0.2 mm or 0.1 mm or 0.08 mm or 0.05 mm. Such a size range may prevent visibility by a human observer (e.g. with 20/20 vision from a typical viewing position, e.g. 30 cm or above from the output aperture of the device).

The minimum diameter D of the decoupling feature 60 is greater than or equal to than 0.001 mm or 0.05 mm or 0.01 mm. Such a minimum size range may ensure that the decoupling feature 60 are convenient to form.

### B. a Minimum Distance Condition:

For any pair of decoupling features i and j located at positions xᵢ and xⱼ, a Euclidean distance dᵢⱼ between the decoupling features satisfies the inequality:

dᵢⱼ=||xᵢ−xⱼ||≥rₘᵢₙ, where rₘᵢₙ∈[A mm],

where rₘᵢₙ is a minimum separation distance between adjacent decoupling features, and A is a bound. rₘᵢₙ may for example be a distance between centre points of the decoupling features 60 or may be a minimum distance between their peripheries.

By implementing a suitable minimum distance condition for any pair of the decoupling features, a clustering condition which may result in more than one decoupling feature being observed as being a one, or other uniformity related issue in the luminance distribution may be avoided.

A may be 0.01 mm or 0.05 mm or 0.08 mm or 0.1 mm or 1 mm. the condition may also be expressed as rₘᵢₙ=A.

### C. A Spacing Condition:

The average spacing between adjacent decoupling features 60 is described by a spatial density function ρ(x), (i.e., how many decoupling features per mm² at point x) such that for any region A⊂² of area A, the expected number of decoupling features [symbol] [N_{A}] within that area is given by:

[symbol]

[N_{A}]=∫_{A}ρ(x)dA, where ρ(x)∈[A decoupling features/mm², B decoupling features/mm²]
where ρ(x) is the spatial density distribution of the decoupling features 60, to avoid both over-concentration and under-concentration dA is an infinitesimal patch of area on the interior surface 50 light guide 18, and A is the lower bound and B is the upper bound decoupling features per area.

By implementing a suitable a density distribution for the decoupling features 60, over-concentration and under-concentration may be avoided. Specifically, per mm² there may not fall below A and may not exceed B decoupling features for any given area over the surface that the decoupling features is formed on.

A may be 0.05 or 10 or 1 or 100. B may be 2500 or 1000 or 500 or 200. Any of the aforesaid values for A and B may be combined, e.g. [0.05/mm², 1000/mm²].

For a regular grid where the repeating unit R is constant, the density distribution is constant over all the area of the interior surface 50.

However, in some examples where the regular grid changes geometry, e.g. to apply more decoupling features with distance from the light source, the density distribution may be variable, but within these ranges. Such an arrangement may be achieved by subdividing repeating unit into same shaped sub units.

### D. a Maximum Distance Condition:

A distance between a first decoupling feature and a second nearest neighbour decoupling feature for any such pair of decoupling features i and j located at positions xᵢ and xⱼ, a distance dᵢⱼ between the decoupling features satisfies the inequality:

dᵢⱼ=||xᵢ−xⱼ||≤rₘₐₓ, where rₘₐₓ∈[A mm]

where rₘₐₓ is the maximum separation distance between adjacent decoupling features, and A is a bound. rₘₐₓ may for example be a distance between centre points of the decoupling features 60 or may be a minimum distance between their peripheries.

By implementing a suitable maximum distance condition for any pair of the decoupling features, a clustering condition which may result in an under concentration being observed, or other uniformity related issue in the luminance distribution may be avoided.

A may be 10 mm or 5 mm or 3 mm or 2 mm or 1 mm. The condition may also be expressed as rₘₐₓ=A.

In variant embodiments, which are not illustrated, one or more of conditions A)-D) may be implemented in the arrangement of the decoupling features.

Moreover, any one of more of conditions A)-D) may be implemented for at least 60% or 80% or 90% of the decoupling features. That is, a negligible amount of the decoupling features may not satisfy one or more of the conditions A)-D) such that the effect caused by these few decoupling features are not easily perceived by an observer.

In the illustrated example, the regular grid formation with the repeating unit R is maintained with different sized (e.g. diameter D) decoupling features 60, which increase with distance in the lateral direction 102 from the light sources 20 to provide a uniform luminance distribution over the output aperture. The specific variation in diameter D can be determined based on the distance, light source configuration etc and may for example be solved by numerical modelling.

In variant embodiments, which are not illustrated, the principle is extended to other numbers of light sources along the edges of the diffuser. For example, with light sources additionally arranged along the edges extending in the lateral direction, with the repeating unit maintained, different sized (e.g. diameter) decoupling features, which increase with distance in the lateral direction and the longitudinal direction from the light sources arranged to provide a uniform luminance distribution over the output aperture.

In variant embodiments, which are not illustrated, the size of the decoupling features 60 and the repeating unit R remains the same with distance from the light source 20, with additional decoupling features 60 being added, e.g. at the centerer of the repeating unit.

Hence more generally, to achieve the uniform luminance distribution, an occupancy area of a sample area (e.g. a square of a preset dimension, including of 1 cm side length, which can comprise one or more decoupling features and/or repeating units) of a surface occupied by the decoupling features increases with distance from the light source, e.g. up to a centre point or other position depending of the arrangement of the light sources around the edges of the waveguide.

The uniformity of the luminance distribution can be characterised as an average luminance measured (e.g. in candelas per square meter (cd/m²)) at an output surface of the light guide for a given sample area (e.g. a square or circle of a preset dimension, including 1 or 10 cm side length/diameter) as not varying by more than 10% or 15% or 20% including for 100% or at least 80% or 90% of the output aperture.

### Pseudo Random Configuration

Referring to FIG. 8 the decoupling features 60 are arranged on said interior surface 50 with a random (e.g. a pseudo-random) distribution.

The decoupling features 60 are arranged on the surface with the pseudo-random distribution such that a spatial arrangement of the decoupling features is governed by a distribution function P(x), with x∈ ², where x² refers to each point X represents a position on the 2D surface of the light guide, typically in Cartesian coordinates.

The following conditions are implemented:
A. A maximum size condition: as discussed for the regular grid example.

### B. a Minimum Distance Condition:

For any pair of decoupling features i and j located at positions xᵢ and xⱼ, a Euclidean distance dᵢⱼ between the decoupling features satisfies the inequality:

dᵢⱼ=||xᵢ−xⱼ||≥rₘᵢₙ, where rₘᵢₙ∈[A mm, B mm,]

where rₘᵢₙ is the minimum separation distance between adjacent decoupling features, and A is a lower bound and B is an upper bound separation distance. rₘᵢₙ may for example be a distance between centre points of the decoupling features 60 or may be a minimum distance between their peripheries.

By implementing a suitable minimum distance condition for any pair of the decoupling features, a clustering condition which may result in more than one decoupling feature being observed as being a one, or other uniformity related issue in the luminance distribution may be avoided.

Instead of fixing rₘᵢₙ to one value, using a range introduces controlled variability in the distances between decoupling features 60. If all decoupling features 60 had exactly the same rₘᵢₙ spacing artefacts including: repetitive spacing, quasi-periodic patterns, Moiré effects could be created.

A may be 0.01 mm or 0.05 mm or 0.08 mm or 1 mm. B may be 3.0 mm or 2.0 mm or 1.0 mm or 0.5 mm or 0.1 mm. Any of the aforesaid values for A and B may be combined, e.g. [0.01 mm, 3.0 mm].

C. A spacing condition: as discussed for the regular grid example.
D. A maximum distance condition:
A distance between a first decoupling feature and a second nearest neighbour decoupling feature for any such pair of decoupling features i and j located at positions xᵢ and xⱼ, a distance dij between the decoupling features satisfies the inequality:

dᵢⱼ=||xᵢ−xⱼ||≤rₘₐₓ where rₘₐₓ∈[A mm, B mm,]

where rₘₐₓ is the maximum separation distance between adjacent decoupling features, and A is a lower bound and B is an upper bound separation distance. rₘₐₓ may for example be a distance between centre points of the decoupling features 60 or may be a minimum distance between their peripheries.

By implementing a suitable maximum distance condition for any pair of the decoupling features, a clustering condition which may result in more than one decoupling feature being observed as being a one, or other uniformity related issue in the luminance distribution may be avoided.

Instead of fixing rₘₐₓ to one value, using a range introduces controlled variability in the distances between decoupling features 60. If all decoupling features 60 had exactly the same rₘₐₓ spacing artefacts including: repetitive spacing, quasi-periodic patterns, Moiré effects could be created.

A may be 0.5 mm or 1 mm or 2 mm 3 mm or 5 mm. B may be 10 mm or 5 mm or 3 mm or 2 mm or 1 mm. Any of the aforesaid values for A and B may be combined, e.g. [2 mm, 10 mm].

### E. A Low-Frequency Periodicity Condition:

The spatial power spectrum S(f) of the pattern of decoupling features, e.g. meaning: how “intense” or “strong” (or energy there is) different spatial frequencies are in the layout of the decoupling features 60 on the light guide, where f is spatial frequency, e.g. how quickly a pattern repeats over space, and satisfies the condition:

S(^{f})∝^{f}^{_{−α}}, with α ∈[A,B]
where the exponent α ensures that the spatial power spectrum decays sufficiently at low spatial frequencies (e.g. higher α values mean faster fall-off of light scattering along the guide),
   and the power at each frequency ^{f} decreases as f increases, controlled by α.

A may be 0.5 or 1 or 1.5 or 2. B may be 5 or 4 or 3 or 2.5. Any of the aforesaid values for A and B may be combined, e.g. [1, 4].

This range of exponent α may ensure that low-frequency components in the spatial spectrum decay sufficiently, which may prevent strong periodicity in the decoupling feature arrangement, which may minimizing large-scale periodicity that would otherwise result in visible aliasing or moiré patterns.

### F. a Cluster Avoidance Condition:

The local clustering measure Ci for each decoupling feature i in the region surrounding its position xᵢ is defined as:

Cᵢ=1/|B(xᵢ, r_{clust})|·Σⱼ_{_{∈}}_{B(xi,rclust)}1{dij ≤{r_{clust}}
where: B(xᵢ, r_{clust}) represents a disk of radius r_{clust} centred at the position xᵢ, the indicator function1{dij≤{r_{clust}} is equal to 1 if the distance dᵢⱼ between the i-th decoupling feature and any other decoupling feature j within the disk is less than or equal to r_{clust}, and 0 otherwise, the clustering measure Cᵢ is optimized such that it remains below a predetermined threshold, [symbol] _{clust}, with the threshold [symbol] ∈[A, B].

A may be 0.05 or 0.01 or 0.015. B may be 0.5 or 0.7 or 0.85. Any of the aforesaid values for A and B may be combined, e.g. [0.01, 0.7].

By ensuring that the clustering is within the range [symbol] _{clust}∈ [0.01, 0.7] noticeable localized bright spots may be avoided.

In variant embodiments, which are not illustrated, one or more of conditions A)-F) may be implemented in the arrangement of the decoupling features.

Moreover, any one of more of conditions A)-F) may be implemented for at least 60% or 80% or 90% of the decoupling features. That is, a negligible amount of the decoupling features may not satisfy one or more of the conditions A)-F) such that the effect caused by these few decoupling features are not easily perceived by an observer.

Various numerical methods may be implemented to determine the pseudo-random distribution according to the above conditions.

For example, the arrangement can be is subject to Poisson disk sampling. Poisson disk sampling may ensure that each decoupling feature maintains a minimum separation from all neighbouring decoupling features to mitigate clustering in high-density regions.

For example, the pseudo-random distribution is subjected to Lloyd's relaxation. Lloyd's relaxation may minimize variance in local decoupling feature density, ensuring a uniform extraction decoupling feature distribution over the surface area.

As for the regular grid example, for the pseudo-random arrangement, to achieve the uniform luminance distribution, an occupancy area of a sample area (e.g. a square of a preset dimension, including of 1 cm side length, which can comprise one or more decoupling features and/or repeating units) of a surface occupied by the decoupling features increases with distance from the light source, e.g. up to a centre point or other position depending of the arrangement of the light sources around the edges of the waveguide. The occupancy area be adjusted by varying the size and or concentration of the decoupling features.

The uniformity of the luminance distribution can be characterised as an average luminance measured (e.g. in candelas per square meter (cd/m2)) at an output surface of the light guide for a given sample area (e.g. a square or circle of a preset dimension, including 1 or 10 cm side length/diameter) as not varying by more than 10% or 15% or 20% including for 100% or at least 80% or 90% of the output aperture.

### Light Source

Referring to FIGS. 4, 7 and 8, the light source 20 comprises a plurality of LEDs. The LEDs have at least 2 or 3 different colours (e.g. RGB; RGBW; BYW; BGW; BGWW). For example, the LEDs can be arranged as a repeating unit of these colours arranged on a circuit board or other substrate.

Each colour is independently controllable by the electrical circuitry 8 as a channel of the same colour LEDs. The LED colours/channels are controllable to achieve a desired colour and/or intensity of the output light.

Specifically, the light sources are independently controllable to produce colour to follow a curve in a chromaticity diagram that is representative of a daylight locus. The control may be to achieve a CCT of a maximum of at least 12,000 K or 15,000 K or 20,000 K or 30,000 K.

### Absence of Masking Diffuser

For the regular grid arrangement and the pseudo random arrangement, since the decoupling features 60 are not visible (e.g. for someone with normal eyesight gazing into the output aperture 12 from a viewing range including greater than 30 cm), nor are they arranged in a manner that might create visible artefacts (such as aliasing or Moire patterns) or other visible features related to their under or over concentration, there is no need to implement a masking diffuser between the wave guide 18 and the output aperture 12.

With the removal of the requirement of the masking diffuser (or other like arrangement to mask the aforementioned optical artefacts/features), the output light 6 between the exterior face 52 of the light guide and the output aperture 12 experiences no more than a drop of 5% or 7.5% or 10% or 15% or 20% in intensity. The minimal drop may be due to the transparent member of the output aperture only, which may be a clear plastic, e.g. an acrylic or glass (but not a masking diffuser).

Due to the absence of this component the device 4 may be narrow in depth dimension, e.g. thickness.

### Use of Device

Whilst the device 2 has been disclosed as being used for creating a virtual sky scene, other uses may also be implemented.

Specifically, the device 2 can be arranged for transmission of light entirely therethrough (as would be the case for the waveguide arrangement with a sun light component projected through the waveguide). Specifically, the device 2 may be arranged with an output aperture on either side of the light guide, without an opaque material therebetween.

For example, the optical display device may be implemented:
1) As a regular/real-life window or skylight, in which the light source may be switched on to provide additional light and/or privacy.
2) Internal window/panel, e.g. as privacy glass/panel to be opaque or to display a message once the light source is switched on.
3) A viewing arrangement for an object, e.g. for artwork, with unform illumination as the light source is switched on.

### 4) As a General Lighting Arrangement, E.g. in Overhead Panel Lighting.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to disclosures containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
4 Device(s)
6 Output light
10 Output light generation system
14 Diffuse light generation system
16 Sky light component
18 Light guide
50 Interior face
60 Decoupling features
52 Exterior face
54 Side face
20 Light source
28 Collimated light generation system
30 Sun light component
32 Light source
34 Collimating system
12 Output aperture
22 Transparent member
36 Interior face
38 Exterior face
40 Side face
24 Frame
42 Interior side face
44 Exterior side face
46 Top face
48 Bottom face
26 Housing
8 Electrical circuitry

1. An optical display device arranged to generate output light projected through an output aperture, the device comprising:
a diffuse light generation system for generating a diffuse light component of the output light, the diffuse light generation system comprising:
a light guide comprising an optically transparent substrate with decoupling features arranged on a surface thereof to decouple light from the light guide as the diffuse light component;
a light source arranged to project light into the light guide;
an output aperture for output of the output light,
wherein the decoupling features are arranged on said surface with a regular grid formation, and at least 80% of the decoupling features satisfies the following conditions:
A. a major dimension condition: a maximum size of the major dimension of a decoupling features of less than or equal to 0.1 mm and a minimum size of the major dimension of greater than or equal to 0.001 mm;
B. a minimum distance condition: for any pair of decoupling features i and j located at positions xᵢ and xⱼ, a distance dᵢⱼ between the decoupling features satisfies the inequality:
dᵢⱼ=||xᵢ−xⱼ||≥rₘᵢₙ where rₘᵢₙ∈[0.01 mm]
where rₘᵢₙ is the minimum separation distance between adjacent decoupling features,
C. a spacing condition: the average spacing between adjacent decoupling features is described by a spatial density function ρ(x), such that for any region A⊂ ² of area A, an expected number of decoupling features N_{A} within that area is given by: [symbol]
[N_{A}]=^{∫}_{A}ρ(x)dA where ρ(x)⊂[0.05 decoupling features/mm², 1000 decoupling features/mm²]
where ρ(x) is the spatial density distribution of the decoupling features, to avoid both over-concentration and under-concentration.

2. The optical display device of claim 1, wherein the regular grid formation comprises: rectangular, hexagonal or triangular grid or other polynomial grid.

3. The optical display device of claim 1, wherein the regular grid formation is maintained with different sized decoupling features which vary with distance from the light source to provide a uniform luminance distribution over the output aperture.

4. An optical display device arranged to generate output light projected through an output aperture, the device comprising:
a diffuse light generation system for generating a diffuse light component of the output light, the diffuse light generation system comprising:
a light guide comprising an optically transparent substrate with decoupling features arranged on a surface thereof to decouple light from the light guide as the diffuse light component;
a light source arranged to project light into the light guide;
an output aperture for output of the output light,
wherein the decoupling features are arranged on said surface with a pseudo-random distribution such that a spatial arrangement of the decoupling features is governed by a distribution function P(x), with x∈ ² representing the 2D coordinates of each decoupling feature on the surface of the light guide, and the following conditions are met for at least 80% of the decoupling features:
A. a major dimension condition: a maximum size of the major dimension of the decoupling features of less than or equal to 0.1 mm and a minimum size of the major dimension of greater than or equal to 0.001 mm;
B. a minimum distance condition: for any pair of decoupling features i and j located at positions xᵢ and xⱼ, a distance dᵢⱼ between the decoupling features satisfies the inequality:
dᵢⱼ=||xᵢ−xⱼ||≥rₘᵢₙ where rₘᵢₙ∈[0.01 mm, 3.0 mm]
where rₘᵢₙ is the minimum separation distance between adjacent decoupling features,,
C. a spacing condition: for the average spacing between adjacent decoupling features is described by a spatial density function ρ(x), such that for any region A⊂ ² of area A, an expected number of decoupling features NA within that area is given by:
[N_{A}]=^{∫}_{A}ρ(x)dA where ρ(x)∈[0.05 decoupling features/mm², 1000 decoupling features/mm²]
where ρ(x) is the spatial density distribution of the decoupling features, avoiding both over-concentration and under-concentration,
D. a low-frequency periodicity condition: the spatial power spectrum S(∫) of the spatial arrangement of the decoupling features, where f represents spatial frequency, and satisfies the condition:
S(∫)∝^{∫-α} with α∈[4.0]
where the exponent α ensures that the spatial power spectrum decays sufficiently at low spatial frequencies, minimizing large-scale periodicity,
E. a cluster avoidance condition: the local clustering measure Cᵢ for each decoupling feature i in the region surrounding its position xᵢ is defined as:
Cᵢ=1/|B(xᵢ, r_{clust})|Σⱼ_{_{∈}}_{B(xi,rclust)}1_{{dij≤{rclust}}
where: B(xᵢ, r_{clust}) represents a disk of radius r_{clust} centered at the position xᵢ and the indicator function1_{{dij≤{rclust}} is equal to 1 if the distance dᵢⱼ between the i-th decoupling feature and any other decoupling feature j within the disk is less than or equal to r_{clust}, and 0 otherwise, the clustering measure Cᵢ is optimized such that it remains below a predetermined threshold, [symbol] _{clust}, with the threshold [symbol] _{clust}∈[0.01, 0.7].

5. The optical display device of claim 4, wherein the decoupling features are arranged with a pseudo random arrangement without a regular repeating unit.

6. The optical display device of claim 4, wherein said pseudo-random distribution is subject to Poisson disk sampling, ensuring each decoupling feature maintains a minimum separation from all neighbouring decoupling features to mitigate clustering in high-density regions.

7. The optical display device of claim 4, wherein said pseudo-random distribution is subjected to Lloyd's relaxation to minimize variance in local decoupling feature density, ensuring a uniform extraction decoupling feature distribution over the surface area.

8. The optical display device of claim 1, wherein at least 80% of the decoupling features satisfy the following condition:
F. a maximum distance condition: a distance between a first decoupling feature and a second nearest neighbour decoupling feature for any such pair of decoupling features i and j located at positions xᵢ and xⱼ, a distance dᵢⱼ between the decoupling features satisfies the inequality:
dᵢⱼ=||xᵢ−xⱼ||≤rₘₐₓ where rₘₐₓ∈[3.0 mm, 10 mm]
where rₘₐₓ is the maximum separation distance between adjacent decoupling features.

9. The optical display device of claim 1, comprising of:
the decoupling features arranged on the surface of the light guide and not arranged distal said surface within the material of the light guide.

10. The optical display device of claim 1, wherein:
the decoupling features have a visual acuity of less than or equal to 1 arcminute when viewed on a viewing plane 30 cm in an orthogonal direction from the decoupling features; and/or
the decoupling features are unresolvable by an observer with normal 20/20 vision at a viewing distance of 30 cm an orthogonal direction from the decoupling features.

11. The optical display device of claim 1, wherein the decoupling features are formed by laser etching or moulding.

12. The optical display device of claim 1, wherein an occupancy area of a sample area of the surface occupied by the decoupling features increases with distance from the light source.

13. The optical display device of claim 12, wherein the distance is up to a first point, which is at an opposed edge of the light guide or at a centre of the light guide.

14. The optical display device of claim 1, wherein an average luminance measured at an output surface of the light guide for a given sample area does not vary by more than 10% or 15% or 20% for at least 90% of the output surface.

15. The optical display device of claim 1, wherein:
between the output aperture and an output surface of the light guide is absent a masking diffuser to mask the decoupling features, said masking diffuser to implement diffuse light in the output light; and/or
the output light between an output surface of the light guide and the output aperture experiences no more than a drop of 5% or 10% in intensity.

16. The optical display device of claim 1 comprising an optically reflective back panel arranged on an opposed side to an output surface of the light guide to reflect light to the waveguide.

17. The optical display device of claim 1, wherein the light guide has one or more of the following dimensions:
a thickness of 0.2 mm to 15 mm;
a side length of 20 cm to 2 m.

18. The optical display device of claim 1 arranged to create a sky scene with the output light, in which the diffuse light component is a diffuse skylight component with a blue or grey colour.

19. A method of generating output light projected through an output aperture, the method comprising:
emitting light from a light source into a light guide;
decoupling the light from the light guide by decoupling features arranged on a surface of the light guide or on a surface of a member optically coupled to the light guide as a diffuse light component;
emitting the diffuse light component through an output aperture,
wherein the decoupling features are arranged on said surface with:
a regular grid formation according to claim 1.

20. A method of generating output light projected through an output aperture, the method comprising:
emitting light from a light source into a light guide;
decoupling the light from the light guide by decoupling features arranged on a surface of the light guide or on a surface of a member optically coupled to the light guide as a diffuse light component;
emitting the diffuse light component through an output aperture,
wherein the decoupling features are arranged on said surface with:
a pseudo random arrangement according to claim 4.
